(19) United States
(12) Patent Application Publication
(10) Pub. No.: US 2011/0025818 A1
(43) Pub. Date: Feb. 3, 2011

(54) System and Method for Controlling Presentations and Videoconferences Using Hand Motions

(76) Inventors: Jonathan Gallmeier, Austin, TX (US); Alain Nimri, Austin, TX (US)

Correspondence Address: WONG, CABELLO, LUTSCH, RUTHERFORD & BRUCCULERI,;L.L.P., 20333 SH 249 6th Floor, HOUSTON, TX, 77070, US

(21) Appl. No.: 12/849,506

(22) Filed: Aug. 3, 2010

Related U.S. Application Data
(63) Continuation-in-part of application No. 11/557,173, filed on Nov. 7, 2006, now Pat. No. 7,770,115.

(51) Int. Cl. H04N 7/15

(52) U.S. Cl. 348/14.07; 348/E07.083

(57) ABSTRACT

A system and method are disclosed for controlling presentations and videoconference using hand motions and/or laser dots from a laser pointer. A camera captures video of an area relative to content displayed on a display device from a content source. A control unit is communicatively coupled to the content source, the display device, and the camera. The control unit receives captured video from the camera. The control unit detects a hand motion by a presenter or a laser dot from a laser pointer that occurs within the captured video and determines the location within the captured video of at least one control for controlling the presentation or videoconference. The control unit determines if the detected hand motion or laser dot occurs within the determined location of the at least one control, and the control unit controls the content source based on the determined control.

### CROSS-REFERENCE TO RELATED APPLICATIONS

This is a continuation-in-part of U.S. patent application Ser. No. 11/557,173, entitled “System and Method for Controlling Presentations and Videoconferences using Hand Motions” and filed 07-NOV-2006, which is incorporated herein by reference and to which priority is claimed.

### FIELD OF THE DISCLOSURE

The subject matter of the present disclosure relates to a system and method for controlling presentations using hand or other physical motions by the presenter relative to the displayed presentation content.

### BACKGROUND OF THE DISCLOSURE

Speakers often use content, such as PowerPoint slides, Excel spreadsheets, etc., during a presentation or videoconference. Often, the speakers must control the content themselves or have a second person control the content for them during the presentation or videoconference. These ways of controlling content can cause distractions. For example, having to call out instructions to another person to flip the slides of a presentation forward or backward can be distracting or not understood. During a presentation, for example, the audience may ask questions that often require jumping to random slides or pages. If a second person is controlling the content, the speaker has to relay instructions to the second person to move to the correct slide.

The subject matter of the present disclosure is directed to overcoming, or at least reducing the effects of, one or more of the problems set forth above.

### SUMMARY OF THE DISCLOSURE

A system and method are disclosed for controlling presentations and videoconference using hand motions and/or laser dots. In one embodiment, the system includes a content source, a display, a camera, and a control unit. The content source can be a computer, a videoconferencing system, a video camera, or other device that provides content. The content can be moving video, images, presentation slides, spreadsheets, live computer screen shots, or other displayable subject matter. The camera captures video of an area relative to the content being displayed on the display device from the content source. The control unit is communicatively coupled to the content source, the display device, and the camera. The control unit receives captured video from the camera. The control unit detects a hand motion by a presenter or a parameter (location, motion, flashing, etc.) of a laser dot that occurs within the captured video and determines the location within the captured video of at least one control for controlling the presentation or videoconference. The control unit determines if the detected hand motion or laser dot parameter has occurred within the determined location of the control and controls the content source based on the control triggered by the hand motion or laser dot parameter.

The at least one control can be shown as a small icon included in the displayed content. In this way, the system allows natural hand motions or laser dots from a laser pointer to control the content of a presentation or videoconference by providing the small icon in the displayed content. To change content or control aspects of the presentation or videoconference, the speaker or presenter needs only to move a hand relative to the icon or transmit the laser dot on the icon so that the camera captures the hand motion or laser dot and the control unit detects that the control of the icon has been selected.

The control icons can be implemented as an overlay on top of the content video, or the control icons can be included as part of the content in the form of an image incorporated into a slide presentation. In another alternative, the control icons can be a physical image placed on the wall behind the presenter or speaker in the view angle of the camera.

The camera is used to capture motions of the speaker or parameters (location, motion, flashing, etc.) of the laser dot regardless of which of the above type of icon is used. In fact, certain controls do not require an icon to be used. In fact, a mere region (e.g., corner) of the displayed content or captured video can be used for a control, such as changing to the next slide in a presentation.

A particular control can be activated when motion vectors in the captured video reach a predetermined threshold in the area or location of the icon. To place icons within the content stream, the content is preferably displayed as a background image using a chroma key technique, and an image pattern matching algorithm is preferably used to find the placement of the icon. If the icon is overlaid on top of the camera video after the camera has captured the video of the speaker, then the placement or location of the icon will be already known in advance so that the control unit will not need to perform an image pattern matching algorithm to locate the icon.

In one benefit of the system, speakers or presenters using the system can naturally control a presentation or videoconference without requiring a second person to change presentation slides, change content, or perform any other various types of control.

The foregoing summary is not intended to summarize each potential embodiment or every aspect of the present disclosure.

### BRIEF DESCRIPTION OF THE DRAWINGS

The foregoing summary, preferred embodiments, and other aspects of subject matter of the present disclosure will be best understood with reference to a detailed description of specific embodiments, which follows, when read in conjunction with the accompanying drawings, in which:

FIG. 1 illustrates an embodiment of a presentation system according to certain teachings of the present disclosure.

FIG. 2A illustrates an embodiment of a presentation control icon overlaying or incorporated into presentation content.

FIG. 2B illustrates an embodiment of a presentation control icon as a physical image placed adjacent presentation content.

FIG. 3 illustrates another embodiment of a presentation system according to certain teachings of the present disclosure.

FIG. 4 illustrates the presentation system according to certain teachings of the present disclosure in schematic detail.

FIGS. 5A-5B illustrates a presentation system in which a laser pointer and generated laser dot are used.

FIGS. 6A-6B illustrates another presentation system in which a laser pointer and generated laser dot are used.

FIG. 7 illustrates a presentation system as in FIGS. 5A through 6B in schematic detail.

FIGS. 8A-8B illustrates a presentation system in which a laser pointer and generated laser dot as well as hand motions and icons are used.

FIGS. 9A-9B illustrates another presentation system in which a laser pointer and generated laser dot as well as hand motions and icons are used.

FIG. 10 illustrates a presentation system as in FIGS. 8A through 9B in schematic detail.

While the subject matter of the present disclosure is susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. §112.

### DETAILED DESCRIPTION

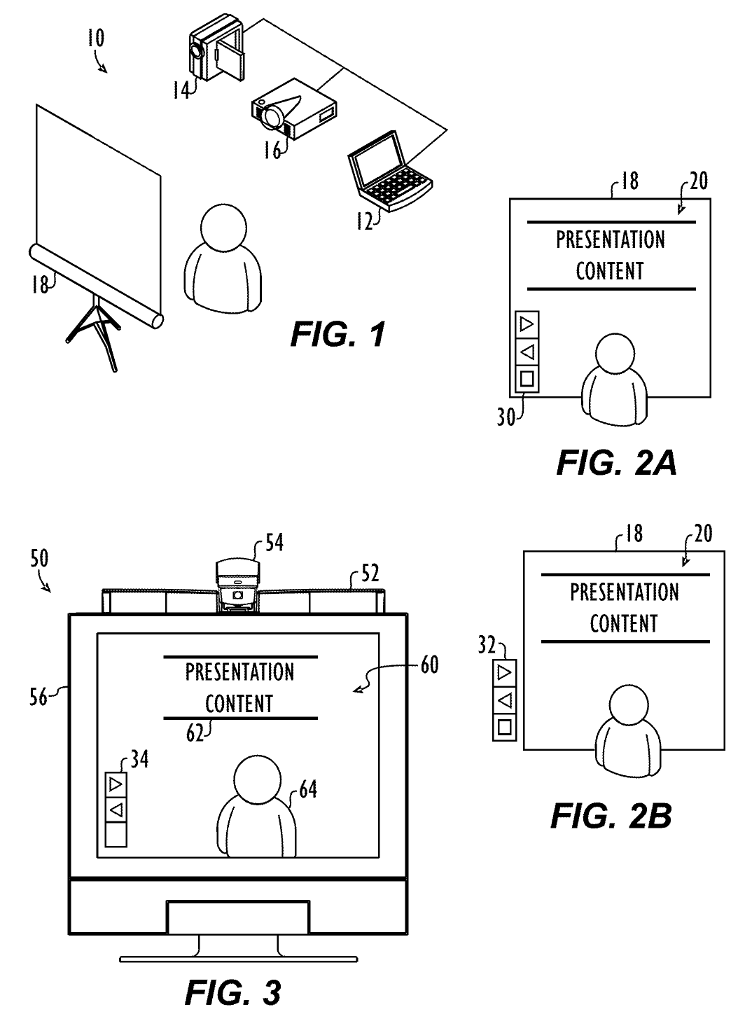

Referring to FIG. 1, an embodiment of a presentation system 10 according to certain teachings of the present disclosure is illustrated. The presentation system 10 includes a control unit 12, a camera 14, and one or more content devices 16 and 18. In the present embodiment, the control unit 12 is shown as a computer, and the camera 14 is shown as a separate video camera. In an alternative embodiment, the control unit 12 and the camera 14 can be incorporated into a single videoconferencing unit. In addition, the present embodiment shows the content devices as a projector 16 and screen 18. In alternative embodiments, the one or more content devices can include a television screen or a display coupled to a videoconferencing unit, a computer, or the like.

The presentation system 10 allows the presenter to use physical motions or movements to control the presentation and the content. As described below, the presenter can use hand motions relative to a video applet, displayed icon, or area to control the playing of video, to change slides in a presentation, and to perform other related tasks associated with a presentation. For example, the control unit 12 includes presentation software for presenting content, such as a PowerPoint® presentation. The control unit 12 provides the content to the projector 16, which then projects the content on the screen 18. In one embodiment, one or more video applets or visual icons are overlaid on the content presented on the screen. As the presenter conducts the presentation, the camera 14 captures video of motion made relative to the displayed icon on the screen 18. This captured video is provided to the control unit 12. In turn, the control unit 12 determines from the captured video whether the presenter has made a selection of a control on the displayed icon. If so, the control unit 12 controls the presentation of the content by performing the control selected by the presenter. In general, the video applets or visual icons can be placed as visual elements over captured video, can be placed as a physical object that is then captured in video, or can be incorporated into a content stream, such as being a visual button in Power point slide.

As noted above, one or more visual icons can overlay content being presented. In FIG. 2A, an example of a visual icon 30 is shown overlaying content 20 displayed on the screen 18. In one implementation, the icon 30 is incorporated into the presentation content. For example, the icon 30 can be added as a graphical element to a slide of a PowerPoint presentation.

In another implementation, the icon 30 can be overlaid or transposed onto the content of the presentation. Either way, the camera (14; FIG. 1) is directed at the screen 18 or at least at the area of the icon 30. During the presentation, the camera (14) captures video of the area of the icon 30 in the event that the presenter makes any motions or movements over the icon 30 that would initiate a control.

In another example, FIG. 2B shows a physical icon 32 placed adjacent the content 20 being displayed on the screen 18. For example, the physical icon 32 can be a plaque or card positioned on a wall next to the screen 18. The camera (14; FIG. 1) directed at the icon 32 captures video of the area of the icon 32 in the event that the presenter makes a motion over one of the controls of the icon 32.

Referring to FIG. 3, another embodiment of a presentation system 50 according to certain teachings of the present disclosure is illustrated. In this embodiment, the presentation system 50 includes a videoconferencing unit 52 having an integral camera 54. The videoconferencing unit 52 is connected to a video display or television 56. The videoconferencing unit 52 is also connected to a network for videoconferencing using techniques known to those skilled in the art. The display 56 shows content 60 of a videoconference. In the present embodiment, the content 60 includes presentation material 62, such as presentation slides, video from the connected camera 54, video from a remote camera of another videoconferencing unit, video from a separate document camera, video from a computer, etc. The content 60 also includes video of a presenter 64 superimposed over the presentation material 62. In addition, an icon 34 is shown in the content 60 on the display 56.

As discussed above, there are several ways to include the icon 34 into the presentation system 50. The icon 34 can be incorporated as a visual element into the presentation material 62, whereby the incorporated icon 34 is presented on the display 56 as part of the presentation material 62. Alternatively, the icon 34 can be a visual element generated by the videoconferencing unit 52, connected computer, or the like and superimposed on the video of the presentation material 62 and/or the video of the presenter 64. In yet another alternative, the icon 34 can be a physical object having video of it captured by the camera 54 in conjunction with the video of the presenter 64 and superimposed over the presentation material 62.

Again, the presentation system 50 allows the presenter 64 to use physical motions or movements to control the presentation and the content 60. For example, the presenter 64, who is able to view herself superimposed on presentation material 62 on the display 56, can use hand motions relative to the displayed icon 34 to control the playing of video, to change slides in a presentation, and to perform other related tasks associated with a presentation.

As discussed above, the icon 34 can be incorporated as a visual element in the presentation material 62 shown on the display 56. For example, the icon 34 can be visual buttons added to slides of a PowerPoint presentation. Because the icon 34 is incorporated into the presentation material 62, the icon 34 will likely have a fixed or know location. The camera 54 captures video of the presenter 64 who in turn is able to see her own hand superimposed on the presentation materials 62 when she makes a hand motion within the area of the incorporated icon 34. The video from the camera 54 is analyzed to detect if a hand motion occurs within the known or fixed location of the icon 34. For example, the analysis determines motion vectors that occur within the video stream of the camera 54 and determine if those motion vectors exceed some predetermined threshold within an area of the icon 34. If the hand motion is detected, then the videoconferencing unit 52 determines what control has been invoked by the hand motion and configures an appropriate command, such as instructing to move to the next slide in a PowerPoint presentation, etc.

As discussed above, the icon 34 can be a visual element added to the video of the presenter 64 captured by the camera 54. The added icon 34 is shown on the display 56 along with the video of the presenter 64. Therefore, the presenter 64 is able to see her own hand when she makes a motion relative to the added icon 34. The video from the camera 54 is analyzed to detect if a hand motion occurs within the known or fixed location of the added icon 34, and the videoconferencing unit 52 determines which control has been invoked by the hand motion.

As discussed above, the icon 34 can be a physical element placed next to the presenter 64 (e.g., located on the wall behind the presenter 64). The location of the physically placed icon 64 can be determined from the video captured by the camera 54. The presenter 64 can make a hand motion relative to the physically placed icon 34, and the camera 54 can capture the video of the presenter's hand relative to the icon 34. The captured video can then be analyzed to detect if a hand motion occurs within the area of the icon 34, and the videoconferencing unit 52 can determine which control has been invoke by the hand motion.

In the embodiments of FIGS. 2A-2B and 3, the icons 30, 32, and 34 can have any of a number of potential controls for controlling a presentation. Each control can be displayed as a part of a separate area of the icons 30, 32, and 34 so that the presenter can move her hand or other object in the separate area to implement the desired control. For example, changing to the next slide in a PowerPoint presentation can simply require that the presenter move her hand over a graphical element of the icons 30, 32, and 34 corresponding to advancing to the next slide. Which controls are used on the icons 30, 32, and 34 as well as their size and placement can be user-defined and can depend on the particular implementation. In addition to controlling a presentation (e.g., moving to next slide, moving back a slide, etc.), embodiments of the disclosed system 100 can be used to control a mouse pointer in a desktop environment, to control camera movements of a videoconference, to control volume, contrast, brightness levels, and to control other aspects of a presentation or videoconference with hand motions.

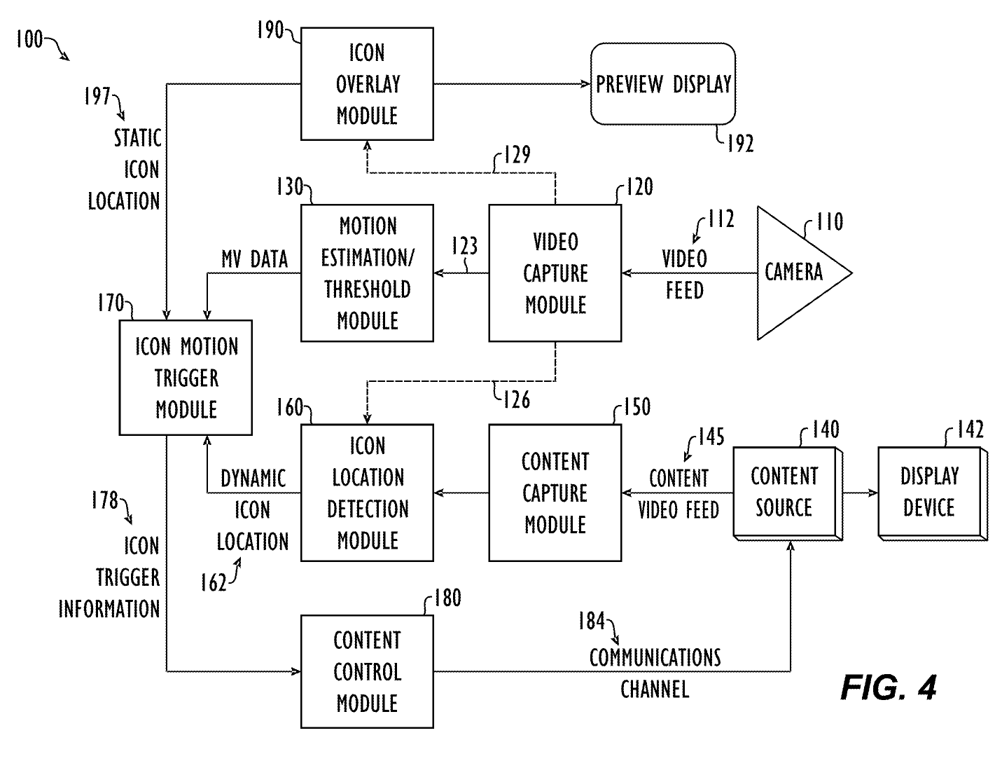

Given the above description, we now turn to a more detailed discussion of a presentation system according to certain teachings of the present disclosure. Referring to FIG. 4, an embodiment of a presentation system 100 according to certain teachings of the present disclosure is schematically illustrated. In the discussion that follows, some components of the presentation system 100 are discussed in terms of modules. It will be appreciated that these modules can be implemented as hardware, firmware, software, and any combination thereof. In addition, it will be appreciated that the components of the presentation system 100 can be incorporated into a single device, such as a videoconferencing unit or a control unit, or can be implemented across a plurality of separate devices coupled together, such as a computer, camera, and projector.

To capture video images relative to an icon, the presentation system 100 includes a camera 110 and a video capture module 120. To handle content, the presentation system 100 includes a content source 140 and a content capture module 150. To handle controls, the presentation system 100 includes an icon motion trigger module 170 and a content control module 180. Depending on how the icon is superimposed, incorporated, or added, the presentation system 100 uses either an icon location detection module 160 or an icon overlay module 190.

During operation, the camera 110 captures video and provides a video feed 112 to the video capture module 120. For videoconferencing, the camera 110 is typically directed at the presenter. In one embodiment, the icon (not shown) to be used by the presenter to control the presentation can be overlaid on or added to the video captured by the camera 110. Accordingly, the location of the icon and its various controls can be known, fixed, or readily determined by the system 100. In this embodiment, the video capture module 120 provides camera video via a path 129 to the icon overlay module 190. At the icon overlay module 190, the icon is overlaid on or added to video that is provided to the preview display 192. In this way, the presenter can see herself on the preview display 192 and can see the location of her hand relative to the icon that has been added to the original video from the camera 110. Because the location of the added icon is known or fixed, the icon overlay module 190 provides a static location 197 of the icon to the icon motion trigger module 170 that performs operation discussed later.

In another embodiment, the icon may not be overlaid on or added to the video from the camera 110. Instead, the icon may be a physical element placed at a random location within the field of view of the camera 110. In this embodiment, the location of the icon and its various controls must first be determined by the system 100. In this case, the video capture module 120 sends video to the icon location detection module 160. In turn, this module 160 determines the dynamic icon location. For example, the icon location detection module 160 can use an image pattern-matching algorithm known in the art to find the location of the icon and its various controls in the video from the camera 110. For example, the image pattern-matching algorithm can compare expected pattern or patterns of the icon and controls to portions of the video content captured with the camera 110 to determine matches. Once the location of the icon and its controls are determined, the module 160 provides the location 162 to the icon motion trigger module 170.

In another embodiment, the icon may be incorporated as a visual element in the content from the content source 140. For example, the icon may be a tool bar added to screens or slides of a presentation from the content source 140. In this embodiment, the content capture module 150 receives a content video feed from the content source 140 and sends captured content video to the icon location detection module 160. One embodiment of the disclosed system 100 uses a chroma key technique and pattern-matching to detect the location of the icon. Because the icon is incorporated as a visual element within the content stream, the content can be displayed as a background image using a chroma key technique. The background image of the content can then be sampled, and the video pixels from the camera 110 that fall within the chroma range of the background pixels are placed in a background map. The edges can then be filtered to reduce edge effects. The icon location detection module 160 can then use an image pattern-matching algorithm to determine the location of the icon and the various controls in the content stream. Once determined, the module 160 provides the location 162 to the icon motion trigger module 170. Other algorithms known in the art can be used that can provide better chroma key edges and can reduce noise, but one skilled in the art will appreciate that computing costs must be considered for a particular implementation.

While the static or dynamic location of the icon is determined as discussed above, the video capture module 120 also provides video information to the motion estimation and threshold module 130. This module 130 determines vectors or values of motion (“motion vector data”) occurring within the provided video content from the camera 110 and provides motion vector data to the trigger module 170. To determine motion vector data, the motion estimation and threshold module 130 can use algorithms known in the art for detecting motion within video. For example, the algorithm may be used to place boundaries around the determined icon or screen location and to then identify motion occurring within that boundary.

In one embodiment, the module 130 can determine motion vector data for the entire field of the video obtained by the video capture module 120. In this way, the motion estimation and threshold module 130 can ignore anomalies in the motion occurring in the captured video. For example, the module 130 could ignore data obtained when a substantial portion of the entire field has motion (e.g., when someone passes by the camera 110 during a presentation). In such a situation, it is preferred that the motion occurring in the captured video not trigger any of the controls of the icon even though motion has been detected in the area of the icon.

In alternative embodiments, the motion estimation and threshold module 130 can determine motion vector data for only predetermined portions of the video obtained by the video capture module 120. For example, the module 130 can focus on calculating motion vector data in only a predetermined quadrant of the video field where the icon would preferably be located. Such a focused analysis by the module 130 can be made initially or can even be made after first determining data over the entire field in order to detect any chance of an anomaly as discussed above.

Continuing with the discussion, the trigger module 170 has received information on the location of the icon—either the static location 197 from the icon overlay module 190 or the dynamic location 162 from the icon location detection module 160. In addition, the trigger module 170 has received information on the motion vector data from the motion estimation and threshold module 130. Using the received information, the trigger module 170 determines whether the presenter has selected a particular control of the icon. For example, the trigger module 170 determines if the motion vector data within areas of the controls in the icon meet or exceed a threshold. When a control is triggered, the trigger module 170 sends icon trigger information 178 to a content control module 180. In turn, the content control module 180 sends control commands to the content source 140 via a communications channel 184.

The previous embodiments focused on the selection of icons based on a presenter's hand motions to control presentations and videoconferences. Additional embodiments disclosed below use a laser pointer and a generated laser dot to control presentations and videoconferences.

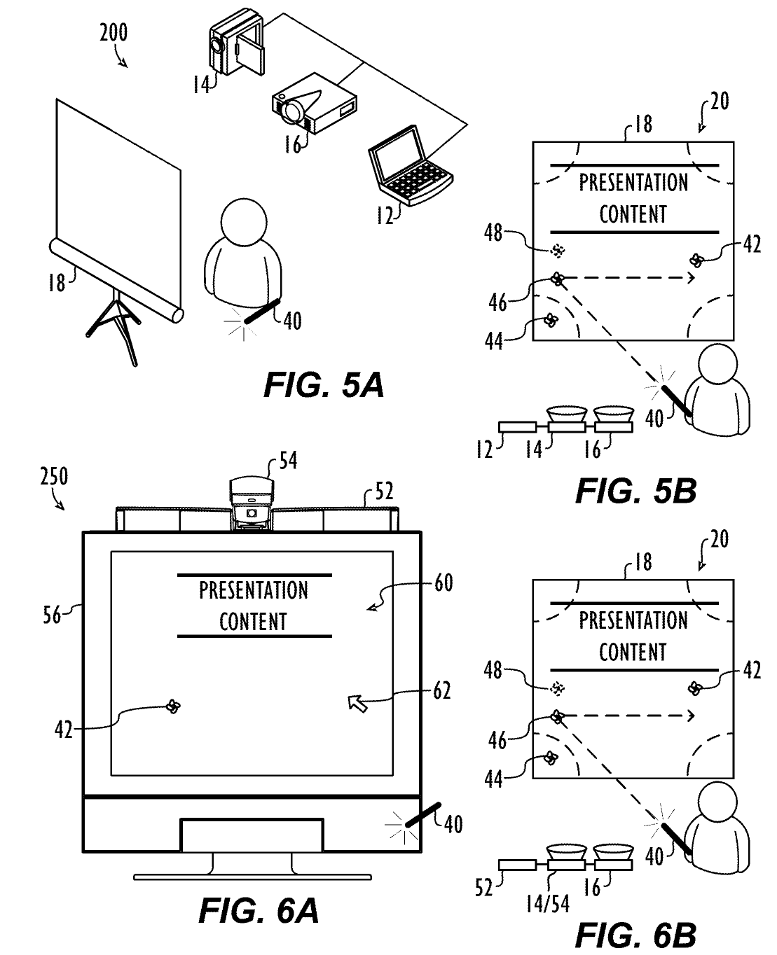

In a presentation system 200 of FIGS. 5A-5B (which is similar to the presentation system 10 in FIG. 1), a presenter uses a laser pointer 40 and a generated laser dot 42 to control a presentation and the content being displayed, thus replacing the functionality of a mouse, a keypad, or a touchpad of a control unit. As with previous embodiments, the presentation system 200 includes a control unit 12, a camera 14, and one or more content devices 16 and 18. (The same alternative embodiments for the presentation system 10 of FIG. 1 are likewise available for the presentation system 200.)

For the presentation, the control unit 12 provides content to a projector 16, which then projects the content onto a screen 18. For example, the control unit 12 can be a computer having presentation software for presenting content, such as a PowerPoint® presentation. As the presenter conducts the presentation, the presenter can use the laser pointer 40 to generate a laser dot 42 on the screen 18 relative to the displayed content 20. Meanwhile, the camera 14 captures video of the laser pointer's dot on the screen 18 having the projected content 20. This camera 14 can be a low resolution monitoring camera focused on the screen 18 or a particular area of the screen 18. The captured video from the camera 14 is provided to the control unit 12, which determines from the captured video whether the presenter has indicated a command with the laser dot 42. If so, the control unit 12 controls the presentation of the content by performing the presenter's command. For example, the presenter can use the laser dot 42 relative to the screen 18 to control the playing of video, to change slides in a presentation, and to perform other related tasks associated with a presentation.

As shown in FIG. 5B, for example, the projector 16 can project content 20 onto the screen 18 while the camera 14 captures video of the screen 18. The presenter uses the laser pointer 40 to generate the laser dot 42 on the screen 18. Ostensibly, the presenter can use the laser dot 42 to point to elements shown in the content 20 as the presenter discusses those elements. All the same, the control unit 12 can detect the location of the laser pointer's dot 42 in the video captured by the camera 14, and the location or motion of the laser dot 42 can indicate a particular command.

For location purposes, the captured video of the camera 14 can be defined as having coordinates, and the location of the laser dot 42 determined as coordinates in the captured video. Through calibration and alignment, these laser dot coordinates can be mapped or correlated to coordinates of the presented content 20 or a particular area or “icon” constituting a control. Additionally, the control unit 12 can detect a frequency of flashing of the laser dot 42 within the captured video. Either way, the location, frequency, motion, or other parameter of the laser dot 42 can correspond to some command for controlling the presentation, and the control unit 12 uses the corresponding command to control the presentation.

One example laser dot 44 in FIG. 5B falls within a particular region (i.e., corner, side, quadrant, etc.) of the screen 18, which may or may not include a visual “icon” in the presented content 20. When captured by the camera 14, the control unit 12 can determine this as indicating a command, such as move to next slide, move to previous slide, etc. Another example laser dot 46 is shown moving in a direction across the screen 18 from one side to the other. This can also indicate a command, such as move to next slide, move to previous slide, etc.

Finally, the example laser dot 48 is shown flashing to indicate a command. For example, the laser pointer 40 can be used to flash the laser dot 48 like clicking a computer mouse to control the local presentation. This would allow for the presenter to open applications and control the computer using the laser pointer 40 as a mouse. Any combination of location, motion, flashing, or other parameter of the laser dot from the laser pointer 40 can be used for applicable commands for controlling the presentation and the system 200.

Referring to FIGS. 6A-6B, another presentation system 250 also uses a laser pointer 40 and a laser dot 42. This system 250 is similar to the presentation system 50 in FIG. 3 and has a videoconferencing unit 52 connected to a network for videoconferencing using techniques known to those skilled in the art. A display 56 shows content 60 of a videoconference and can include presentation slides, video from a connected camera 54, video from a remote camera of another videoconferencing unit, video from a separate document camera, video from a computer, etc.

As shown in FIG. 6A, the presentation system 250 allows remote participants in the videoconference to view the laser dot 42 in the content 60 of the videoconference. Accordingly, the content 60 on the display 56 also includes video of the laser dot 42 from the laser pointer 40 handled by the presenter. The video of the laser dot 42 can be part of or superimposed over the content 60 being displayed. Moreover, rather than the laser dot 42, the content 60 can include a graphical pointer 62 that is superimposed over the location of the laser dot 42 generated by the presenter. Using the laser dot 42 or pointer 62, the presenter can point to elements shown in the content 60 as the presenter discusses those elements, and remote participants of the videoconference can see the dot 42 or pointer 62 during the videoconference.

In addition to displaying the laser dot 42 or pointer 62 in the content 60, the presentation system 250 allows the presenter to use the laser pointer 40 and laser dot 42 to control the videoconference and the presentation of the content 60. As shown in FIG. 6B, for example, a projector 16 can project content 20 locally onto a screen 18 while either a local camera 14 or the videoconferencing unit's camera 54 captures video of the screen 18. This local content 20 can be the same content displayed on the display 56. In fact, the captured video from the camera 14/54 of the local content 20 can be directly used for the displayed content 60. Alternatively, the displayed content 60, although the same as the local content 20, can come directly from a content source (computer, videoconferencing unit, etc.) without using the captured video of the camera 14/54 except for information on the laser dot 42.

As the videoconference progresses, for example, the presenter uses the laser pointer 40 to generate the laser dot 42 on the screen 18. In turn, the camera 14/54 can capture video of both the projected content 20 and the laser dot 42 on the screen 18, and this captured video can be displayed on the video screen 56 as content 60 shown in FIG. 6A. Alternatively, only the location of the generated laser dot 42 is used in this captured video, and its location superimposed or associated with the original content 60 for display on the video display 56.

Rather than projecting local content 20 and capturing video of the laser dot 42 relative thereto, the camera 14/54 can capture video of a wall, a screen, or other blank surface so there is no need of the projector 16 and projected content 20. The presenter holding the laser pointer 40 can transmit the laser dot 42 onto the blank surface, and the camera 14/54 can capture video of the laser dot 42 on the blank surface. This captured video can then be superimposed on or overlaid over content 60 from videoconferencing unit 52, computer, or other content source, or the captured video can be used to generate a pointer 62 to be superimposed on the content at the laser dot's location. The combined video of the content 60 and laser dot 42 or pointer 62 can then be displayed on the video display 56 as shown in FIG. 6A both locally and remotely.

For the pointer 62, the videoconferencing unit 52 can determine the location of the laser dot 42 in the presentation content 60 and can superimpose a graphic of the pointer 62 at the detected location of the laser dot 42. In turn, this graphic pointer 62 can be added to the content 60 on the unit 52 being sent to the display 56. Thus, in a meeting, the content 60 can include an image of the pointer 62 that is used in the meeting to point at various parts of the projected presentation material by the presenter. This can be useful when the meeting is viewed by presenters at both the near and far-end of a videoconference.

In the above variations, the captured video from the camera 14/54 is analyzed to detect one or more defined parameters of the laser dot 42. In general, the laser dot parameters can include location, motion, flashing, or other possible parameters. For example, the analysis can determine motion vectors that occur within the video stream of the camera 14/54 and determine if those motion vectors exceed some predetermined threshold and/or if they occur within some particular area of the presentation content 20/60, screen 18, viewing area of the camera 14/54, or the like.

If a defined parameter of the laser dot 42 is detected, then the videoconferencing unit 52 determines what control has been invoked by the parameter and configures an appropriate command, such as instructing to move to the next slide in a presentation, ending a videoconference call, switching to another content source, etc. For example, the videoconferencing unit 52 can detect the dot's location (e.g., dot 44), motion (e.g., dot 46), or flashing (e.g., dot 48) in the video captured by the camera 14/54. Either way, the location, frequency, motion, or other parameter of the laser dot 42 can correspond to some command for controlling the presentation or videoconference, and the videoconferencing unit 52 uses the corresponding command to control the presentation or videoconference.

Again, the laser dot 44 falling within a particular region (i.e., corner, side, quadrant, etc.) of the captured video can indicate a command to move to the next slide, move to previous slide, etc. The laser dot 46 moving in a direction of the captured video from one side to the other can also indicate a command, such as move to next slide, move to previous slide, etc. Finally, the laser dot 48 flashing in the captured video can indicate a command, such as stopping the videoconference or changing the source of content to be displayed during the videoconferences. With the benefit of the present disclosure, one skilled in the art will appreciate these and other commands are possible based on the laser dot's parameters.

In a video conference, for example, the videoconferencing unit 52 can track the laser dot 42 from the laser pointer 40 as captured by the camera 14/54. This can then be used to control the presentation material. Additionally, the tracked laser dot 42 can be displayed as a simulated laser dot or pointer 62 that mimics the position of the local pointer's dot 42. In a web conference, for example, slides can be displayed locally from a content source (e.g., a computer) to the projector 16. The videoconferencing unit 52, which can be the same computer, can send the displayed slide to far sites via a web conference connection. A simulated laser dot or pointer 62 can be incorporated on the displayed slides. This simulated pointer 62 can track the laser pointer's dot 42 on the projector's screen 18 and can be transmitted to all sites in the web conference that are viewing the slides.

In the embodiments of FIGS. 5A through 6B, there can be any of a number of potential commands for controlling a presentation and a videoconference. Each command can be part of a separate area of the content so that the presenter can transmit the laser dots 42 in separate areas to implement the desired control. For example, changing to the next slide in a presentation can simply require that the presenter flash the laser dot 42 in a corner section of the presentation content. In addition or as an alternative to being dependent on the location of the laser dot 42 in content, each command can depend on motion vectors of the laser dot 42 or flashing of the laser dot 42. Which commands are available as well as how and where they are initiated can be user-defined and can depend on the particular implementation. In addition to controlling the presentation (e.g., moving to next slide, moving back a slide, etc.), embodiments of the disclosed systems 200/250 can be used to control a mouse pointer in a desktop environment, to control camera movements of a local or remote videoconference camera 54, to control volume, contrast, brightness levels, and to control other aspects of a presentation or videoconference.

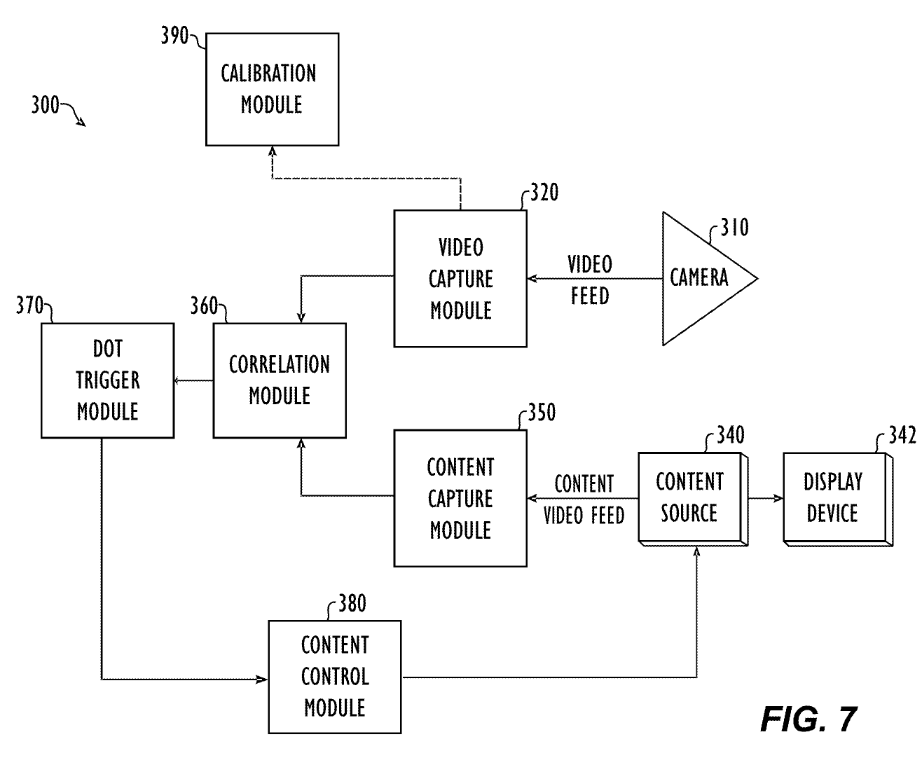

Given the above description, we now turn to a more detailed discussion of a presentation system according to certain teachings of the present disclosure. A presentation system 300 schematically illustrated in FIG. 7 can correspond to the systems 200/250 of FIGS. 5A through 6B and can be similar to the presentation system 100 in FIG. 4. Thus, the same alternative implementations of the modules for presentation system 100 are also available to presentation system 300.

To capture video images, the presentation system 300 includes a camera 310 and a video capture module 320. To handle content, the presentation system 300 includes a content source 340 and a content capture module 350. To handle controls, the presentation system 300 includes a correlation module 360, a dot trigger module 370, and a content control module 380.

During operation, the camera 310 captures video and provides a video feed to the video capture module 320. Again, this video can capture an image of projected content with a laser dot (42) from a laser pointer transmitted thereon. Alternatively, the video can capture a blank wall or other surface with the laser dot (42) generated thereon. In any event, a calibration module 390 can be used with the video capture module 320 to calibrate the system 300 such that the laser dot (42) can be accurately mapped to a location on projected content, a screen, a blank wall, a viewing area of the camera 310, or the like. For example, software of the calibration module 390 can allow the user to calibrate the captured view of the camera 310 to a virtual location of the presentation content. This may involve the presenter going through a calibration scheme in which the location of a transmitted laser dot (42) on a screen as captured by the camera 310 is aligned to a location of an icon or area in the control unit's presentation content as projected and/or displayed.

With calibration performed at set up or at some other time, the system 300 can determine the location of the laser dot (42). In this case, the video capture module 320 sends captured video to a correlation module 360. In turn, this module 360 determines the dynamic laser dot location. For example, the module 360 can use an image pattern-matching algorithm known in the art to find the location of the laser dot (42) in the video from the camera 310. Once the location of the laser dot (42) is determined, the module 360 provides the location to the dot trigger module 370.

For its part, the content capture module 350 receives a content feed from the content source 340 and sends content information to the correlation module 360. One embodiment of the disclosed system 300 uses a chrome key technique and pattern-matching to detect the location of the laser dot (42) relative to the content. For location purposes, the captured video of the camera 310 can be defined as having coordinates, and the location of the laser dot (42) can be determined as coordinates in the captured video. Through calibration and alignment, these laser dot coordinates can be mapped or correlated to coordinates of the presented content provided from the source 340.

Because the laser dot (42) can be incorporated as a visual element within the content stream, the content can be displayed as a background image using a chroma key technique. The background image of the content can then be sampled, and the video pixels from the camera 310 that fall within the chroma range of the background pixels are placed in a background map. The edges can then be filtered to reduce edge effects. The correlation module 360 can then use an image pattern-matching algorithm to determine the location of the laser dot (42) in the content stream. Once determined, the module 360 provides the location to the dot trigger module 370. Other algorithms known in the art can be used, and one skilled in the art will appreciate that computing costs must be considered for a particular implementation.

Because the camera 310 may capture a skewed view of projected content that does not align with the original content from the content source 340, the correlation module 360 receives the capture video and the content information, and the module 360 can performs a keystone correction to correct for any offset between the projected image and the camera 310. With the laser dot located and corrected, the module 360 can superimpose or incorporate the laser dot (42) or pointer (62) in the output video that that is both displayed locally on the display device 342 and transmitted to the remote videoconference participants.

While the dynamic location of the laser dot (42) can be determined as discussed above, the video capture module 320 can also provide video information to the correlation module 370 to determine vectors or values of motion (“motion vector data”) occurring within the video from the camera 310. In this way, the module 360 can analyze the video and provide motion vector data to the dot trigger module 370. To determine motion vector data, the module 360 can use algorithms known in the art for detecting motion within video. For example, the algorithm may be used to place boundaries around a determined screen location and to then identify motion occurring within that boundary using differences between subsequent frames of video. This and other techniques can be used as disclosed herein.

In one embodiment, the module 360 can determine motion vector data for the entire field of the video obtained by the video capture module 320. In this way, the module 360 can ignore anomalies in the motion occurring in the captured video. For example, the module 360 could ignore data obtained when a substantial portion of the entire field has motion (e.g., when someone passes by the camera 310 during a presentation). In such a situation, it is preferred that the motion occurring in the captured video not trigger any of the commands of the laser dot even though motion has been detected in a particular area associated with a control.

In alternative embodiments, the module 360 can determine motion vector data for only predetermined portions of the video obtained by the video capture module 320. For example, the module 360 can focus on calculating motion vector data in only a predetermined quadrant of the video field or other area associated with a control. Such a focused analysis by the module 360 can be made initially or can even be made after first determining data over the entire field in order to detect any chance of an anomaly as discussed above.

Continuing with the discussion, the dot trigger module 370 has received information on the dynamic location of the laser dot. In addition, the trigger module 370 may have received information on the motion vector data of the laser dot 42. Using the received information, the dot trigger module 370 determines whether the presenter has selected a particular control using the laser dot's location, motion, flashing or the like—either alone or in relation to an area in the captured video or the source 340's content. For example, the dot trigger module 370 determines if the laser dot's location lies in a specific area of the captured video corresponding to some aligned area in the content, if the laser dot is detected as flashing in a particular area, or if the motion vector data within the designated areas of the presentation material meet or exceed a threshold.

When a command is triggered, the dot trigger module 370 sends trigger information to the content control module 380. In turn, the content control module 380 sends control commands to the content source 340 via a communications channel. As noted above, the command can include any suitable command for controlling presentation content during a presentation or videoconference. Although not shown, the dot trigger module 370 can also send command information to other components of the system 300, including the camera 310, display device 342, videoconferencing unit (not shown), etc. to control operation of the videoconference as noted herein.

The previous embodiments focused on the selection of commands based on either a presenter's physical motions relative to an icon or use of a laser pointer's dot to control presentations and videoconferences. Additional embodiments disclosed below allow use of hand motions, a laser pointer, or a combination of both to control a presentation and a videoconference.

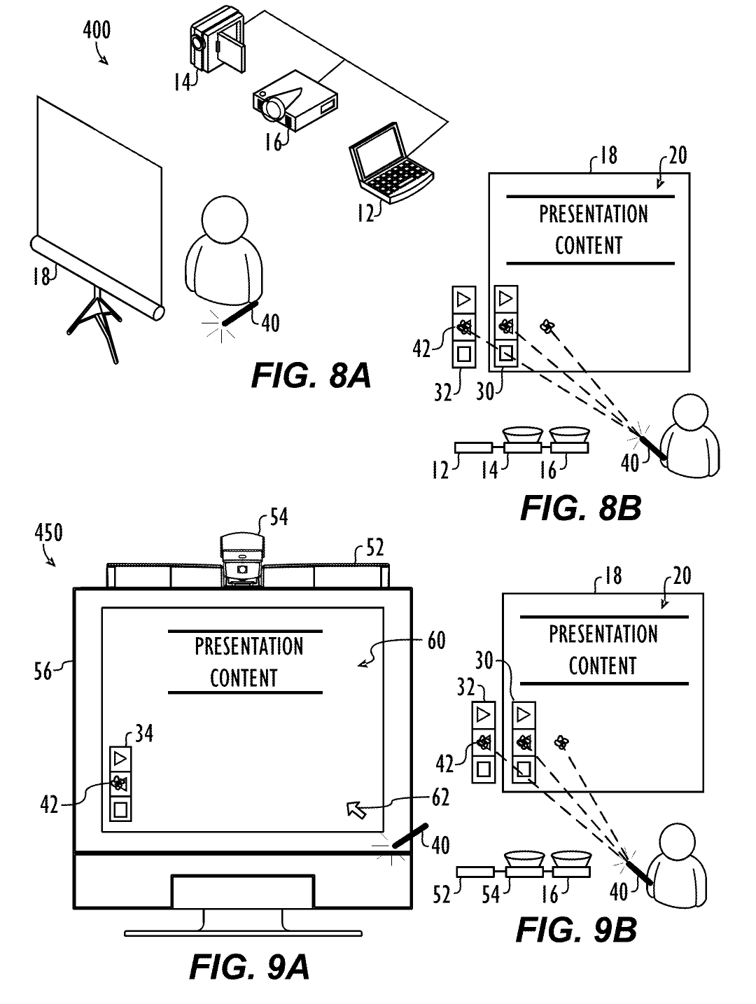

Referring to FIGS. 8A-8B, a presentation system 400 similar to the presentation system 200 in FIGS. 5A-5B allows the presenter to use hand motions, a laser pointer's dot 42, or a combination of both to control the presentation and the content. Similar components have the same reference numerals. As before, the presenter can use hand motions or laser dots 42 relative to a screen 18 having projected content 20 to control tasks associated with a presentation. As the presenter conducts the presentation, the camera 14 captures video of a hand motion or a laser dot 42 and provides it to the control unit 12. In turn, the control unit 12 determines from the captured video whether the presenter has made a selection of a control either on a displayed icon or in some region of the captured video. If so, the control unit 12 controls the presentation of the content by performing the control selected by the presenter.

As noted previously, icons 30 can be added as a graphical element to the presentation content 20 or overlaid on the content 20 when projected on the screen 18, as illustrated in FIG. 8B. Alternatively, an icon 32 can be a physical icon placed adjacent the content 20 being displayed on the screen 18. Either way, the camera 14 is directed at the screen 18 or at least at the area of the icon 30/32. During the presentation, the camera 14 captures video of the area of the icon 30/32 in the event that the presenter makes any hand motions or transmits the laser dot 42 over the icon 30/32 to initiate a control. When not transmitted on the icons 30/32, the laser pointer's dot 42 can be used elsewhere on the displayed content 20 to point to presented elements without eliciting a control function. However, if the camera 14 captures a wider view, other locations, motions, flashing, and other parameters of the laser dot 42 can be used as described previously, while hand motions in the wide view may be excluded.

Referring to FIGS. 9A-9B, a presentation system 450 similar to the presentation system 250 in FIG. 6A-6B allows a presenter to use hand motions, a laser pointer's dot 42, or a combination of both to control the videoconference and the presentation of content. Similar components have the same reference numerals. As before, the presenter can use hand motions or laser dots 42 relative to a screen 18 having locally projected content 20 to control tasks associated with a videoconference. As the presenter conducts the videoconference, the videoconferencing unit's camera 54 or an ancillary camera 14 captures video of the hand motion or laser dot 42 and provides it to the videoconferencing unit 52. In turn, the unit 52 determines from the captured video whether the presenter has made a selection of a control on a displayed icon or other area of the captured video. If so, the unit 52 controls the videoconference or the presentation of the content by performing the control selected by the presenter.

As noted previously, an icon 30 can be added as a graphical element into the local content 20 or overlaid on the content 20 displayed on the screen 18, as illustrated in FIG. 9B. Alternatively, the icon 32 can be a physical icon placed adjacent the content 20 being displayed on the screen 18. Finally, the icon 34 can be incorporated into displayed content 60 on the video display 56 and may not necessarily be displayed to the presenter on the projected screen 18 or the like. Instead, the presenter may point the laser pointer 40 at a blank wall or screen captured by the camera 14/54, and the presenter can use a preview display of the content 60 on their local display 56 with the superimposed icon 34 to determine the location of the laser dot 42 or hand motion and its relation to the superimposed icon 34.

Either way, the camera 14/54 is directed at the screen 18, blank wall, or at least at the area of displayed icons 30/32/34. During the presentation, the camera 14/54 captures video of the area of the icons 30/32/34 in the event that the presenter makes any hand motions or places the laser dot 42 over the icons 30/32/34 to initiate a control. When not used over a control 30/32/34, the laser pointer's dot 42 can be used elsewhere on the displayed content 20 to point to presented elements without eliciting a control function, although certain parameters of the laser dot's location, motion, flashing or the like may still be used for control purposes as described previously. As also discussed in previous embodiments, the laser dot 42 captured in the video can have a pointer 62 or the like added to the displayed content 60 on the videoconferencing display 56.

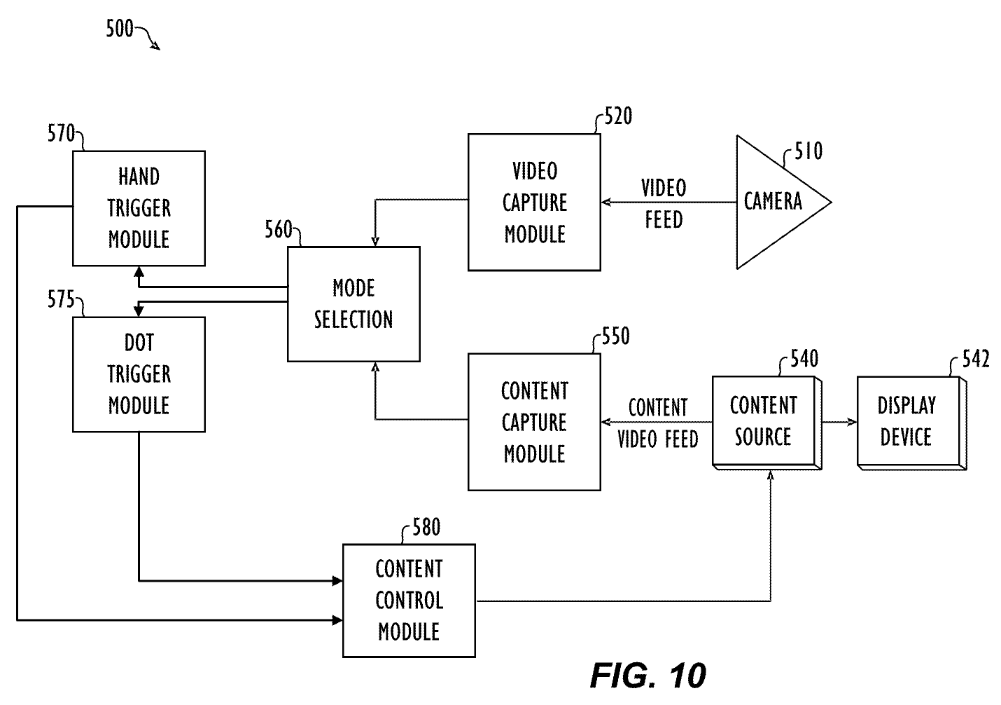

Given the above description, we now turn to a more detailed discussion of a presentation system according to certain teachings of the present disclosure. A presentation system 500 schematically illustrated in FIG. 10 can correspond to the systems 400/450 of FIGS. 8A through 9B and can be similar to the presentation systems 100 in FIG. 4 and 300 in FIG. 7. Accordingly, the same alternative implementations of the previously disclosed modules are also available to presentation system 500.

To capture video images, the presentation system 500 includes a camera 510 and a video capture module 520. To handle content, the presentation system 500 includes a content source 540 and a content capture module 530. To handle controls, the presentation system 500 includes a mode selection module 560, a hand trigger module 570, a dot trigger module 575, and a content control module 580.

During operation, the camera 510 captures video and provides a video feed to the video capture module 520. Again, this video can capture an image of projected content or capture a blank wall or other surface. In any event, a calibration module (not shown) can be used with the video capture module to calibrate the system 500. At the same time, the content capture module 530 receives a content feed from the content source 540.

The video and content capture modules 520/530 provide information to a mode selection module 560, which then determines whether hand motions and/or laser pointer dot information will be used to control the presentation and videoconference. This mode selection can be initiated at start up of the system 500 or can be set dynamically during operation of the system 500 either automatically by using rules or manually by the user using a particular control interface of the system 500.

Either way, information pertaining to hand motions and/or laser dots is sent to either one or both of the hand trigger module 570 and dot trigger module 575 depending on the selected mode. These modules 570/575 incorporate all of the previous capabilities disclosed previously for detecting hand motions; detecting laser dots; determining locations, motion, flashing, or other laser dot parameters; and other features discussed previously so that they are not described again here.

Using the received information, the trigger modules 570/575 determine whether the presenter has selected a particular control using the hand motions and/or using the laser dot's location, motion, flashing or the like. When a command is triggered, the trigger module 570/575 sends trigger information to the content control module 580. In turn, the content control module 580 sends control commands to the content source 540 via a communications channel or to other components of the system 500 to control the videoconference. As noted above, the command can include any of suitable command for controlling the videoconference and the presentation content during a videoconference.

The foregoing description of preferred and other embodiments is not intended to limit or restrict the scope or applicability of the inventive concepts conceived of by the Applicants. For example, the embodiment of the presentation system 100 of FIG. 4 has been described as having both an icon overlay module 190 and an icon location detection module 160. It will be appreciated that the presentation system 100 can include only one or the other of these modules 160 and 190 as well as including both. In another example, embodiments of the systems 50, 100, 250, 300, 450, and 500 have been described in the context of videoconferencing. However, with the benefit of the present disclosure, it will be appreciated that the disclosed system and associated methods can be used in other implementations, such as PowerPoint presentations, closed circuit video presentations, video games, etc. Moreover, a content source for the disclosed system can be a computer, a videoconferencing system, a video camera, or other device that provides content. The content for the disclosed system can be moving video, still images, presentation slides, live views of a computer screen, or any other displayable subject matter. These and other alternatives will be appreciated with the benefit of the present disclosure.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A presentation method, comprising:
defining at least one control in a control unit;
defining in the control unit a parameter in captured video indicative of the at least one control;
capturing video with a camera;
detecting with the control unit the defined parameter in the captured video associated with the at least one control; and
controlling with the control unit content communicated from a content source by using the at least one control having the detected parameter.

2. The method of claim 1, wherein capturing video comprises capturing video of a laser dot produced by a laser pointer.

3. The method of claim 2, wherein defining the parameter comprises defining a parameter of the laser dot within the captured video.

4. The method of claim 2, further comprising superimposing a pointer in the content at a location of the laser dot in the captured video.

5. The method of claim 1, further comprising displaying the content locally, and wherein capturing video comprises capturing video of the displayed local content.

6. The method of claim 5, wherein displaying the content locally comprise incorporating at least one visual icon associated with the at least one control into the content being displayed.

7. The method of claim 6, wherein capturing video comprises capturing video of the at least one visual icon.

8. The method of claim 1, wherein capturing video comprises capturing video of at least one physical icon associated with the at least one control.

9. The method of claim 1, wherein defining the at least one control comprises incorporating at least one visual icon associated with the at least one control into captured video.

10. The method of claim 1, wherein detecting the defined parameter comprises determining a location of a laser dot within the captured video, the location associated with the at least one control.

11. The method of claim 10, wherein detecting the defined parameter comprises correlating the location of the laser dot to a location of at least one icon in the captured video.

12. The method of claim 1, wherein detecting the defined parameter comprises:
determining motion data of a laser dot in the captured video; and
determining whether the motion data indicates the at least one control.

13. The method of claim 1, wherein detecting the defined parameter comprises:
determining flashing of a laser dot in the captured video; and
determining whether the flashing indicates the at least one control.

14. The method of claim 1, wherein detecting the defined parameter comprises detecting a physical motion in the captured video occurring at a defined location of the at least one control.

15. The method of claim 14, wherein controlling the content comprises using the at least one control corresponding to the determined location having the detected physical motion.

16. The method of claim 1, wherein controlling the content communicated from the content source comprises one or more of altering an aspect of the content communicated from the content source, switching to a new content source, controlling an aspect of the camera as the content source having the captured video as the content, or controlling the content communicated from the control unit as the content source.

17. A program storage device, readable by a programmable control device, comprising instructions stored on the program storage device for causing the programmable control device to perform a presentation method according to claim 1.

18. A presentation control method, comprising:
capturing video with a camera of a laser dot produced by a laser pointer;
defining in a control unit a parameter of the laser dot within the captured video indicative of at least one control;
analyzing with the control unit the captured video for the defined parameter of the laser dot; and
controlling operation of the control unit by using the at least one control with the defined parameter.

19. A presentation system, comprising:
a display device for displaying content;
a camera for capturing video; and
a controller communicatively coupled to the display and the camera and communicatively coupled to a content source providing content for display, the controller having a parameter defined for captured video of the camera, the parameter indicative of at least one control, the controller receiving captured video from the camera and detecting the defined parameter in the captured video associated with the at least one control, the controller controlling the content provided by the content source based on the at least one control having the detected parameter.

20. The system of claim 20, wherein the system comprises a videoconferencing unit at least having the camera and the controller.

21. The system of claim 20, wherein the system comprises a computer at least having the controller and the content source.

22. The system of claim 20, wherein the display comprises a video display.

23. The system of claim 20, wherein the display comprises a projector.

24. The system of claim 20, wherein the defined parameter comprises a parameter of a laser dot within the captured video.
